(19) United States
(12) Patent Application Publication
(10) Pub. No.: US 2015/0206040 A1
(43) Pub. Date: Jul. 23, 2015

(54) TRANSPORTABLE DEVICE COMPRISING A TRANSPONDER

(71) Applicant: HARSCO INFRASTRUCTURE SERVICES GMBH, 40885 Ratingen (DE)

(72) Inventor: Volker Klehr, Viersen (DE)

(73) Assignee: HÜNNEBECK GMBH, Ratingen (DE)

(21) Appl. No.: 14/430,928

(22) PCT Filed: Sep. 25, 2013
(86) PCT No.: PCT/EP2013/069913

§ 371 Date: Mar. 25, 2015

(30) Foreign Application Priority Data
Sep. 28, 2012 (DE) 10 2012 217 828.7

(51) Int. Cl. G06K 19/07; G06K 19/077

(52) U.S. Cl. CPC G06K 19/0723; G06K 19/07749

(57) ABSTRACT

The invention relates to a transportable device with a transponder of an RFID system which draws its energy via the associated reading device. The transponder is disposed in a depression consisting of metal. The invention particularly relates to a transportable device used in storage facilities and on construction sites in connection with the erection of buildings, such as, for example, a formwork element, a transport container or a transport device for components such as anchoring rods or locking devices or other formwork element accessories.

A slit extends along the depression in order thus to make long read-out ranges for the transponder possible.

The invention relates to a transportable device with a transponder of an RFID system which draws its energy via the associated reading device. The transponder is disposed in a depression consisting of metal. The invention particularly relates to a transportable device used in storage facilities and/or on construction sites in connection with the erection of buildings, such as, for example, a formwork element, a transport container or a transport device for components such as anchoring rods or locking devices or other formwork element accessories.

A device is transportable within the sense of the present invention if it is intended to be transported for its use. A device that is to be used at different locations and should and must therefore be transported, is transportable within the sense of the present invention. For example, a formwork element is dismantled after the completion of a wall or ceiling and transported to a new site for producing another wall or ceiling. Therefore, a formwork element is transportable within the sense of the present invention.

An RFID system according to the present invention is comprised of a passive transponder that contains or may contain information stored in the memory of the transponder and a reading device for reading out the stored information. In addition, the reading device supplies the transponder with energy during reading.

A formwork element comprises a formwork facing on the front and metal elements, such as longitudinal beams, crossbars and frames, supporting the formwork facing on the back. If the formwork element is a wall formwork, there are anchoring rod bores leading through the supporting elements and the formwork facing. In the erected state of a wall formwork, longitudinal beams extend in the vertical direction and crossbars in the horizontal direction.

The two sides of a wall to be concreted are delimited by wall formworks. With its formwork facing, the front of each wall formwork in that case adjoins the concrete. Wall formworks facing each other are retained by anchoring rods and locking devices. Anchoring rods are pushed through anchoring rod bores and attached at their ends by means of locking devices to the elements supporting the respective formwork facing in such a way that at least the tensile force acting upon the anchoring rods during concreting is absorbed. Document WO 2008/098755 A1 discloses a formwork element with a formwork facing and an outer frame consisting of metal. A depression, which is larger than a flat transponder, is provided on the outer frame. The transponder is disposed and retained in this depression.

The above-mentioned features, which are known from the prior art, can be combined, individually or in any combination, with the subject matter of the invention described below.

Document DE 20 2010 005 092 U1 describes an item with a depression and a transponder in the depression. The depression is formed by a container consisting of metal or plastic.

Document DE 10 2010 038 474 A1 discloses a formwork element with a formwork frame and a formwork facing. An RFID tag is attached to the back of the formwork facing. The formwork facing consists of wood or plastic.

A slotted antenna for a transponder is known from DE 103 57 695 A1.

US 2006/0232412 A1 discloses an RFID chip and a slotted antenna.

It is the object of the invention to further develop a device with a transponder.

The object of the invention is achieved by a device having the features of claim 1. Advantageous embodiments are apparent from the dependent claims.

In order to achieve the object, there is provided a transportable device consisting at least partially of metal with a transponder, which is disposed in a depression consisting of metal. In contrast to the prior art known from WO 2008/098755 A1 there is a slit on the rear of the transponder, i.e. in the bottom of the depression.

A slit within the sense of the present invention is an elongated opening at the bottom of the depression. The opening passes through the bottom of the depression.

By means of the transponder, information can be kept ready to be read out without the transponder being required to have its own source of energy for this purpose. Furthermore, it was found that the read-out range of the transponder could be increased considerably in comparison to the prior art due to the arrangement with a depression with a slit. The read-out range of the transponder is to be understood as the distance that must be maintained in order to be able to read out the information stored in the transponder by means of a transponder reading device.

It was found that the read-out range of a transponder could be increased in an exemplary case from 10 cm to 2 m to 4 m by providing the slit. By increasing the range, it is possible to make the read-out process much easier. The use of a transponder for the purpose of identification and the like in a device according to the claims can therefore be expanded significantly due to the invention. Especially in connection with devices used on construction sites, an increase of the range is of particular interest.

The arrangement of the transponder in a depression protects the transponder against damage. Furthermore, it is possible, in a technically simple way, to attach the transponder to the device in a loss-proof and protected manner.

In one embodiment of the invention, the slit extends over more than 80% of the length of the bottom of the depression. In an advantageous embodiment, the bottom of the depression has a length of, for example, 140 mm to 150 mm. The slit extending along the bottom in that case has a length of at least 112 mm to 120 mm. In an improved manner, a slit of that length contributes to long read-out ranges being possible.

In one embodiment of the invention, the antenna or antennas of the transponder extend in a manner complementary to the slit. In that case, the antenna or antennas extend around a slit. The slit around which the antennas extend is then located above the slit provided at the bottom of the depression. In that case, there is a metallic substrate underneath the antennas. This metallic substrate has a slit that corresponds to the respective slits at the antennas. It was found that particularly long read-out ranges can thus be achieved.

In one embodiment of the invention, the width of the slit is 20-50%, preferably 30-40% of the width of the bottom of the depression. A central region at the bottom of the depression may, however, be exempt from this dimensioning. This specified value therefore primarily relates to regions along the length of the depression. On the one hand, a transponder can thus be reliably fastened in the depression. On the other hand, this depression suffices for making long read-out ranges possible.

In an advantageous embodiment of the invention, there is, in the above-mentioned central region, a preferably circular opening at the bottom of the depression, with a diameter that is larger than the width of the slit. The chip of the transponder is then located above this opening. It was found that long read-out ranges can thus be made possible in an additionally improved manner. For this reason, the base area of the opening is preferably adapted to the base area of the chip, and preferably slightly larger. If, for example, the chip has a rectangular base area, then it is to be preferred that the opening also has such a rectangular base area.

In an advantageous embodiment of the invention, the transponder is disposed in a metallic corner region of the device. In contrast to the other arranging options, a corner region is accessible as a rule, so that it is ensured, in an additionally improved manner, that there is a possibility of reading out.

In order to be able in practice to read out at any time, as a rule, without having to use an excessively large plurality of transponders, two diagonally opposite corners of the device are each provided with a transponder in one embodiment. It was found that this arrangement is sufficient in almost all cases to be able to read out without having to previously move the device for reading out.

In order to ensure in an additionally improved manner that reading out is possible, all of the metallic corners of the device are provided with a transponder.

In one embodiment of the invention, the transponder is retained in the depression by means of an adhesive, in particular a potting material. This attachment or fastening of the transponder is possible in a technically simple manner. Adhesive is furthermore capable of offering protection against dirt.

In one embodiment of the invention, the transponder is alternatively or additionally retained in the depression by means of a positive fit. This embodiment also enables a particularly simple and reliable attachment of the transponder on the device.

The transponder is read out, as is known from document WO 2008/098755 A1, via the open side of the depression, i.e. the side disposed opposite from the bottom of the depression. This open side is therefore disposed in such a way that it is accessible in order to make it possible to read out the transponder.

The shape, width and length of the open side preferably correspond to the shape, width and the length of the bottom of the depression.

In one embodiment of the invention, the transponder is disposed in an outer frame of a formwork element.

In one embodiment of the invention, the outer frame is formed by a closed profile. Advantageously, it is thus prevented that concrete can enter the profile, which could at least affect the reading out of the transponder negatively.

In one embodiment of the invention, the transponder is located in the depression in such a way that it can and is covered with an adhesive and/or a potting material at its side facing towards the outer side. In particular, it is an adhesive that serves for covering. This covering for the transponder, i.e. the potting material, for example, in that case does not protrude over the outer surface adjacent to the depression, i.e. over the upper edge of the depression. By this embodiment, the transponder is protected particularly well.

In an advantageous embodiment of the invention, the surface of the covering facing towards the open side of the depression is recessed relative to the outer surface adjacent to the depression. Thus, the transponder and the covering are protected in an additionally improved manner against disadvantageous external influences.

However, a flush fitting is to be particularly preferred, because it is then possible to dispose the transponder particularly close to the surface, which results in further improved read-out ranges.

In one embodiment of the invention, the transponder is embedded in a plastic mass, i.e. surrounded from all sides with the plastic mass. Thus, the transponder is protected in an additionally improved manner against disadvantageous external influences.

In one embodiment of the invention, a corner of the device comprises a plurality of transponders, each of which are located in a depression. The transponders of a corner are disposed relative to one another in such a manner that the openings of the depressions point in different directions. This embodiment facilitates the reading out in an additionally improved manner. Particularly advantageously, each side of a metallic corner therefore has a depression and a slit with a transponder located therein. Each corner basically comprises three sides.

In one embodiment of the invention, steel or aluminum is provided as the metal forming the depression.

In one embodiment of the invention, the depression has a depth of at least 2 mm. This depth has proved to be sufficient in order to be able to reliably protect a transponder inserted therein against disadvantageous external influences.

In one embodiment of the invention, the depression has a depth of no more than 5 mm, preferably no more than 3 mm. An excessively large construction space and interferences due to too great a depth are thus avoided.

In an advantageous embodiment of the invention, antennas of the transponder extend along a straight line, with a portion of the transponder being disposed between the antennas, preferably centrally. A symmetrical structure is to be particularly preferred. A transponder constructed in this way is particularly suitable to make long read-out ranges possible in connection with the depression and the slit and the otherwise metallic substrate.

The shape of the bottom of the depression is preferably only slightly larger compared to the base area of the transponder. A reliable attachment of the transponder to the device is thus ensured in an additionally improved manner, without having to provide an excessively large construction space for this purpose.

Preferably, the transponder has two antennas along a straight line, between which a chip is located. This antenna design advantageously contributes to achieving long read-out ranges.

Advantageously, there are at the end distant from the chip two arms that are preferably disposed parallel to an approximately rectangular base area of each antenna. This embodiment contributes to long read-out ranges in an additionally improved manner.

Though long read-out ranges can also be obtained by the power of the reading device being increased accordingly, this is prevented, however, by safety guidelines that limit the admissible power of a reading device.

A depression and a slit with a transponder located therein are located, in particular, at a corner of the device. In the case of a formwork element, the depression and the slit and transponder are preferably located at an end face adjacent to a corner of a frame consisting of metal, in order to be able in practice to always read out the information stored therein reliably.

In RFID systems, distinctions are also made with regard to frequency. The HF range 13.56 MHz is primarily intended for short-range systems (payment systems, access systems, near-field systems (NFC). In contrast, the UHF range 868 MHz (EU) is suitable for considerably longer ranges. Preferably, an RFID system is used therefore which makes longer ranges possible due to the corresponding very high frequency.

In the drawings:

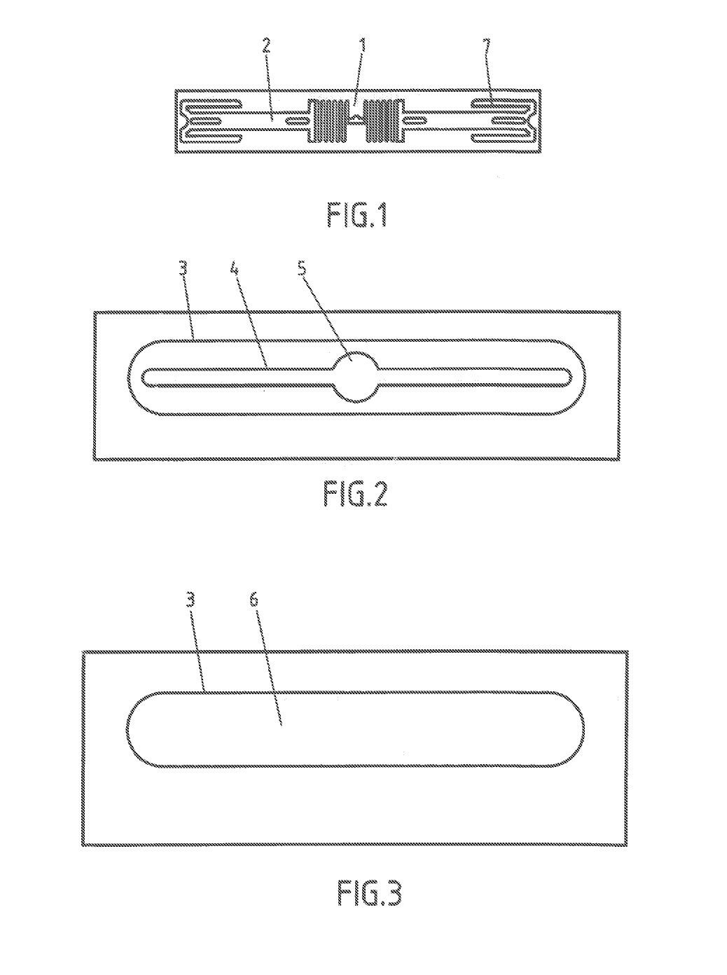

FIG. 1 shows the structure of a transponder,

FIG. 2 shows the depression; top view onto a depression,

FIG. 3 shows a top view onto a depression with a transponder located therein,

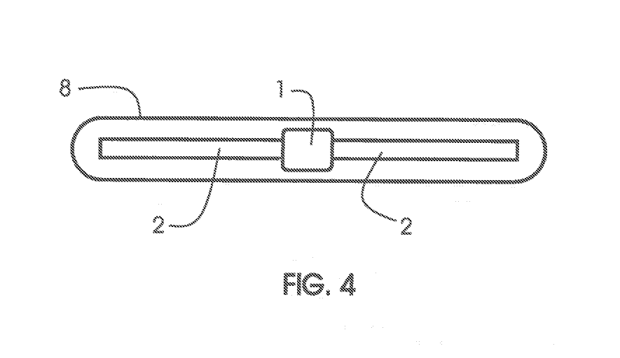

FIG. 4 shows the structure of a transponder.

FIG. 1 illustrates a first possible structure of a transponder with a chip 1 and, based thereon, one antenna 2 respectively, wherein the two antennas 2 extend along a straight line. This approximately results in a rectangular base area of the transponder. The antennas 2 include a substantially rectangular base area. At the ends of the rectangular base area facing away from the central region with the chip 1, there are antenna arms 7 on both sides that extent parallel to the rectangular base area.

FIG. 2 shows a top view onto a depression 3 formed by a metal sheet. At the bottom of the depression 3, there is a slit 4 having in its center a circular opening 5. The bottom of the depression 3 has a length of 148 mm. The slit 4 has a length of 136 mm. The bottom of the depression 3 has a depth of 22 mm. The slit 4 has a width of 8 mm. The circular opening 5 has a diameter of 14 mm. The depression has a depth of 2.4 mm.

FIG. 3 shows a top view onto a depression 3 with a transponder 6 located therein. The base area of the transponder 6 corresponds to the base area of the recess 3. The surface of the transponder 6 is recessed relative to the surface adjacent to the depression 3. In this way, the transponder 6 is protected very reliably against disadvantageous external influences. In order to protect the transponder in an additionally improved manner, it is furthermore embedded in a potting material, such as an epoxy resin.

FIG. 4 shows a particularly preferred embodiment of a transponder with a chip 1, which may have a round or at least approximately square or rectangular base area. Starting from the chip 1, two antennas 2 extend in opposite directions. These antennas 2 have a base area that respectively surround a rectangular slit 8. In this embodiment, the slit 8 around which each antenna 2 extends is located above the slit 4 at the bottom of the depression. This embodiment, by which a metallic substrate is provided for the area of the antennas, makes particularly long read-out ranges possible.

1. A transportable device with a transponder disposed in a depression consisting of metal, wherein the bottom of the depression is provided with a slit, and wherein the transponder comprises a chip disposed between two antennas.

2. The device according to claim 1, wherein the antenna of the transponder or the antennas of the transponder extend in a manner complementary to the slit.

3. The device according to claim 1, wherein a metallic substrate is present underneath the antenna or the antennas of the transponder.

4. The device according to claim 1, wherein the length of the slit is more than 80% of the length of the bottom of the depression and/or the width of the slit is 20 to 50% of the width of the bottom of the depression and/or the slit has in a central region a preferably circular opening which is larger than the width of the slit.

5. The device according to claim 1, wherein the depression has a depth of 2 to 5 mm.

6. The device according to claim 1, wherein the transponder is disposed in a corner region of the device.

7. The device according to claim 6, wherein all of the metallic corner regions of the device are provided with one or more transponders respectively disposed in metallic depressions with a slit.

8. The device according to claim 1, wherein the transponder is firmly glued into the depression.

9. The device according to claim 1, wherein the transponder is embedded into a plastic mass.

10. The device according to claim 9, wherein the surface adjacent to the depression protrudes over the surface of the plastic mass and/or of the transponder or ends flush with the surface of the plastic mass.

11. The device according to claim 1, wherein the transponder, the depression and the slit are made in such a way that the transponder can be read out from a distance of at least 2 m.

12. (canceled)

13. The device according to the claim 1, wherein the two antennas (2) extend along a straight line and/or respectively extend around a slit.

14. The device according to claim 1, wherein the device is a formwork element.

15. The device according to claim 1, wherein the device is a transport device.

16. The device according to claim 15, wherein the device is a stacking frame.

17. The device according to claim 15, wherein the device is a transport container.
